(19) United States
(12) Patent Application Publication
(10) Pub. No.: US 2024/0335934 A1
(43) Pub. Date: Oct. 10, 2024

(54) POWER TOOL INCLUDING A LOW QUIESCENT CURRENT DC LINK BUS DISCHARGE CIRCUIT

(71) Applicant: MILWAUKEE ELECTRIC TOOL CORPORATION, Brookfield, WI (US)

(72) Inventors: Matthew C. Noel, Fond du Lac, WI (US); Daniel R. Ertl, Kewaskum, WI (US)

(21) Appl. No.: 18/290,991

(22) PCT Filed: Jul. 28, 2022
(86) PCT No.: PCT/US2022/074280

§ 371 Date: Jan. 22, 2024

Related U.S. Application Data
(60) Provisional application No. 63/227,469, filed on Jul. 30, 2021.

(51) Int. Cl. B25F 5/02; H02J 7/00

(52) U.S. Cl. CPC B25F 5/02; H02J 7/0013; H02J 7/0036

(57) ABSTRACT

A power tool device that includes a housing, a battery pack interface configured to receive at least one battery pack, a first battery pack terminal and a second battery pack terminal, a low quiescent current direct current (“DC”) link bus discharge circuit including a DC link bus capacitance, a first DC link bus switch, and a second DC link bus switch, and a controller. The controller is configured to monitor a voltage of the first battery pack terminal, monitor a voltage of the second battery pack terminal, turn ON the first DC link bus switch and the second DC link bus switch when the voltage of the first battery pack terminal is greater than a first threshold value and the voltage of the second battery pack terminal is zero volts.

### RELATED APPLICATIONS

This application claims the benefit of U.S. Provisional Patent Application No. 63/227,469, filed Jul. 30, 2021, the entire content of which is hereby incorporated by reference.

### FIELD

Embodiments described herein provide battery pack powered devices.

### SUMMARY

Embodiments described herein provide systems and methods that allow safe-to-touch battery pack terminals after a battery pack has been disconnected from a power tool.

Power tool devices described herein include a housing, a battery pack interface configured to receive at least one battery pack, a first battery pack terminal and a second battery pack terminal, a low quiescent current direct current (“DC”) link bus discharge circuit including a DC link bus capacitance, a first DC link bus switch, and a second DC link bus switch, and a controller. The controller is configured to monitor a voltage of the first battery pack terminal, monitor a voltage of the second battery pack terminal, turn ON the first DC link bus switch and the second DC link bus switch when the voltage of the first battery pack terminal is greater than a first threshold value and the voltage of the second battery pack terminal is zero volts.

In some aspects, the power tool devices further include a third DC link bus switch connected to the first DC link bus switch.

In some aspects, the controller is configured to activate the third DC link bus switch is when the voltage of the second terminal is greater than a battery pack presence voltage threshold value.

In some aspects, the battery pack presence voltage threshold value is 18V or less.

In some aspects, the first DC link bus switch is deactivated when the voltage of the first battery pack terminal is greater than the first threshold value and the voltage of the second battery pack terminal is greater than a second threshold value.

In some aspects, the at least one battery pack includes a first battery pack and a second battery pack.

In some aspects, the first threshold value is between 18V and 36V.

In some aspects, the first threshold value is 25V.

Power tool devices described herein include a housing, a battery pack interface configured to receive at least one battery pack, a low quiescent current direct current (“DC”) link bus discharge circuit including a discharge resistor and a discharge switch, and a controller. The controller is configured to determine when the power tool device is not in operation, implement a delay interval subsequent to it being determined that the power tool device is not in operation, activate, after the end of the delay interval, the discharge switch to discharge voltage stored on a DC link bus through the discharge resistor.

In some aspects, the controller is configured to provide a turn ON command to a controller pin after the end of the delay interval.

In some aspects, the power tool device is configured to disconnect the battery pack interface from a DC link capacitance using a solid state disconnect circuit.

In some aspects, the controller is configured determine a safe to handle state of the power tool device.

Methods of controlling a power tool device described herein include monitoring a voltage of a first battery pack terminal, monitoring a voltage of a second battery pack terminal, activating a first DC link bus switch and a second DC link bus switch when the voltage of the first battery pack terminal is greater than a first threshold value and the voltage of the second battery pack terminal is zero volts.

In some aspects, the methods further include activating a third DC link bus switch when the voltage of the second terminal is greater than a battery pack presence voltage threshold value.

In some aspects, the battery pack presence voltage threshold value is 18V or less.

In some aspects, the methods further include deactivating the first DC link bus switch when the voltage of the first battery pack terminal is greater than the first threshold value and the voltage of the second battery pack terminal is greater than a second threshold value.

In some aspects, the first threshold value is between 18V and 36V.

In some aspects, the first threshold value is 25V.

In some aspects, the methods further include determining a safe to handle state of the power tool device.

In some aspects, the methods further include connecting the first battery pack terminal to a first battery pack and the second battery pack terminal to a second battery pack.

Before any embodiments are explained in detail, it is to be understood that the embodiments are not limited in its application to the details of the configuration and arrangement of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%, or more) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Other aspects of the embodiments will become apparent by consideration of the detailed description and accompanying drawings.

### BRIEF DESCRIPTION OF THE DRAWINGS

FIG. 1 illustrates a plurality of battery packs that can be used with various devices.

FIG. 2 illustrates a simplified block diagram of a power tool device.

FIG. 3 illustrates an embodiment of a portion of an inverter bridge that is configured to control the power tool device of FIG. 2.

FIG. 4 illustrates a battery pack terminal block of the power tool device of FIG. 2.

FIG. 5A and FIG. 5B illustrates different sized battery packs for use with the power tool device of FIG. 2.

FIG. 6 illustrates a battery pack terminal block for the battery packs of FIGS. 5A and 5B.

FIG. 7 is a simplified block diagram of the battery packs of FIGS. 5A and 5B.

FIG. 8 illustrates a low quiescent current capacitor discharge circuit.

FIG. 9 illustrates a method implemented using the capacitance control system of FIG. 8.

FIG. 10 illustrates a solid state disconnect circuit.

FIG. 11 illustrates a method implemented using the solid state disconnect circuit of FIG. 10.

### DETAILED DESCRIPTION

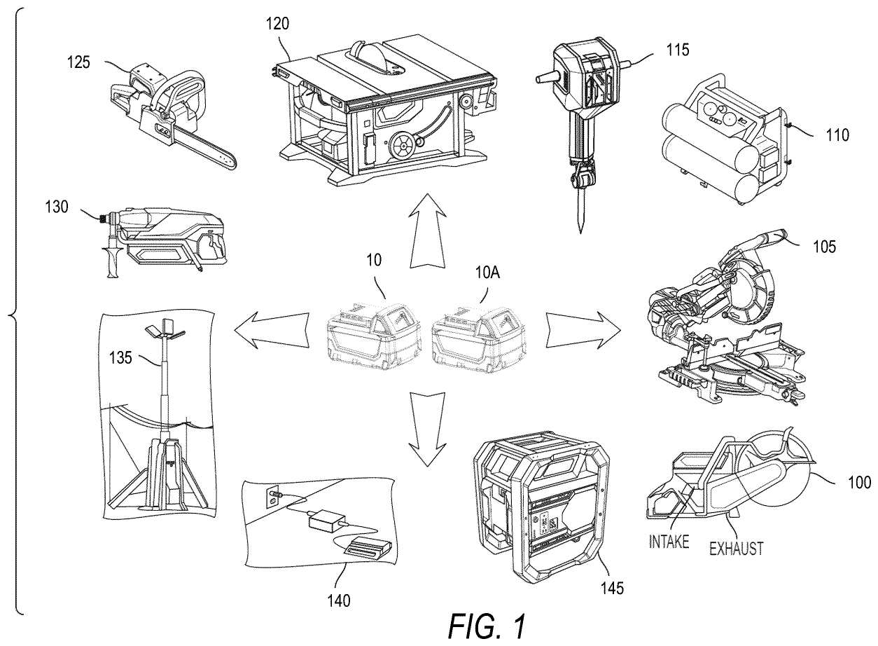

FIG. 1 illustrates a high-power electrical system to which multiple battery packs 10, 10A may be attached. The high-power electrical system includes various high-power electrical devices enabled to receive and utilize multiple battery packs, and subsequently use a quiescent circuit to allow for a discharging of a capacitor. For example, the high-power electrical system includes hand-held devices (i.e., devices configured to be supported by an operator during use) and non-hand-held devices (i.e., devices supported on a work surface or support rather than by the operator during use). Such devices include motorized power tools (e.g., a drill, an impact driver, an impact wrench, a rotary hammer, a hammer drill, a saw [a circular saw, a cut-off saw 100, a reciprocating saw, a miter saw 105, a table saw 120, etc.], a core drill 130, a breaker 115, a demolition hammer compressor 110, a pump, etc.), outdoor tools (e.g., a chain saw 125, a string hammer, a hedge trimmer, a blower, a lawn mower, etc.), drain cleaning and plumbing tools, construction tools, concrete tools, other motorized devices (e.g., vehicles, utility carts, wheeled and/or self-propelled tools, etc.), etc. and non-motorized electrical devices (e.g., a power supply 145, a light 135, an AC/DC adapter 140, a generator, etc.).

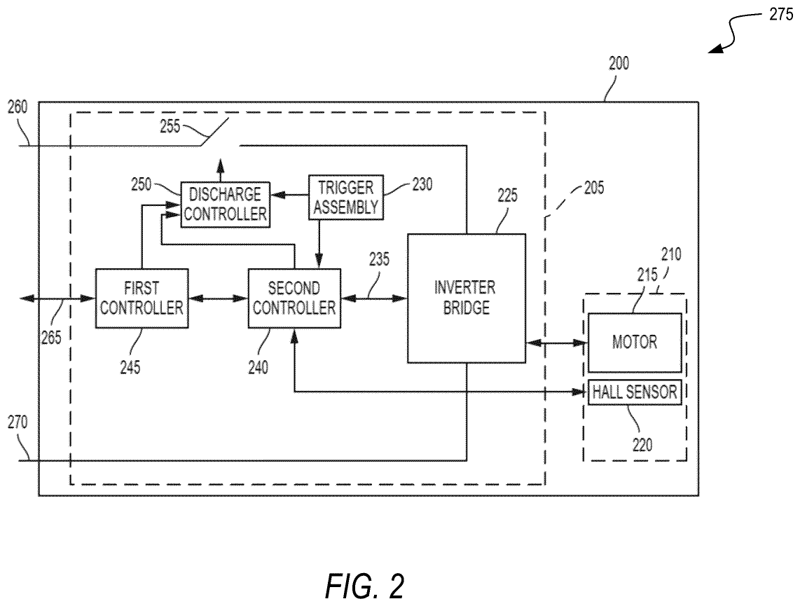

FIG. 2 illustrates a simplified block diagram of an embodiment illustrating an electronics assembly 275 and a motor assembly 210 of a power tool or power tool device 200. The electronics assembly 275 includes circuitry to couple to several embodiments of circuits that allow for low quiescent current and safe discharge of capacitors. The electronics assembly 275 includes a positive power input terminal 260, a negative power input terminal 270, a first controller 245, a second controller 240, an inverter bridge 225, and a trigger assembly 230. The motor assembly 210 includes a motor 215 and a rotor position sensor assembly 220. The electronics assembly 275 may also include additional user inputs, for example, a mode selector switch, a speed dial, a clutch setting unit, etc. In some embodiments, the electronics assembly 275 may include a power switch in addition to or in place of the trigger assembly 230.

The functionality of the implemented circuit may be divided between the first controller 245 and the second controller 240. For example, the first controller 245 may be a main controller of the system, whereas the second controller 240 is an application controller controlling one or more applications of the implemented circuit. In some embodiments, the second controller 240 may be a motor controller controlling operation of the inverter bridge 225 and the motor 215, and the first controller 245 may be a main controller that performs other functionality of the implemented circuit. By distributing the functional load of the high-capacity and high-powered implemented circuit, and by particularly separating motor control functionality from a first controller 245, thermal load is distributed among the first controller 245 and the second controller 240. This thermal distribution thereby reduces the thermal signature of the implemented circuit.

In some embodiments, the first controller 245 and/or the second controller 240 are implemented as microprocessors with separate memories. In other embodiments, the first controller 245 and/or the second controller 240 may be implemented as microcontrollers (with memory on the same chip). In other embodiments, the first controller 245 and/or the second controller 240 may be implemented partially or entirely as, for example, field programmable gate arrays (FPGA), application specific integrated circuits (ASIC), hardware implemented state machines, etc., and the memory may not be needed or modified accordingly.

In some embodiments, the second controller 240 and the motor assembly 210 may be part of a single motor package. This motor package offers modularity for future applications. For example, multiple motor packages, each including a motor assembly 210 and a second controller 240, may be assembled in the implemented circuit and controlled by a single first controller 245.

A communication protocol may be implemented between the first controller 245 and the second controller 240 in order to maintain an uninterrupted operation of the implemented circuit. In one example, the first controller 245 and the second controller 240 may communicate over a communication bus 235 such as a serial peripheral interface (SPI) bus. The first controller 245 and the second controller 240 may be configured such that the first controller 245 and the second controller 240 exchange communications at a certain time interval. The time interval may be, for example, between 3 milliseconds (ms) to 15 ms. The first controller 245 may also communicate with a battery pack controller over a communication link 265.

As described above, in some embodiments, the second controller 240 controls the operation of motor 215 through the inverter bridge 225. The first controller 245 is communicatively coupled to the trigger assembly 230. The trigger assembly 230 may include, for example, a potentiometer, a distance sensor, etc., to determine and provide an indication of the distance the trigger is pulled to the first controller 245. The first controller 245 reads and processes the trigger information and provides the trigger information to the second controller 240. The second controller 240 is communicatively coupled to the rotor position sensor assembly 220. As described above, the rotor position sensor assembly 220 provides an absolute rotational position of the rotor and/or the rotational speed of the rotor. The second controller 240 performs an open loop or closed loop control of the motor 215 through the inverter bridge 225 based on the signals received from the first controller 245 (e.g., trigger information) and the rotor position sensor assembly 220. In some embodiments, the first controller 245 and the second controller 240 are communicatively coupled to the rotor position sensor assembly 220 to provide redundancy for monitoring rotation speed.

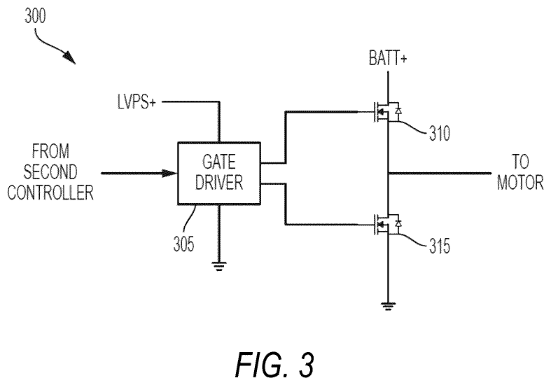

FIG. 3 illustrates an embodiment 300 of a portion of the inverter bridge 225 that controls the power supply to the three-phase (e.g., U, V, and W) of the motor 215 of the power tool device 200. The inverter bridge 300 includes gate drivers 305, high-side FETs 310, and low-side FETs 315 for each phase of the motor 215. The high-side FETs 310 and the low-side FETs 315 are controlled by the corresponding gate drivers 305.

In some embodiments, the inverter bridge 300 may include more than one high-side FET 310 and more than one low-side FET 315 per phase in order to provide redundant current paths for each phase. Although FIG. 3 illustrates only one set of a gate driver 305, a high-side FET 310, and a low-side FET 315, the inverter bridge 300 includes three sets of gate drivers 305, high-side FETs 310, and low-side FETs 315, one for each phase of the motor 215.

The high-side FETs 310 receive battery power supply at the drain of the high-side FETs 310. The source of the high-side FETs 310 is connected to the motor 215 (e.g., phase coil of the motor 215) to provide battery power supply to the motor 215 when the high-side FETs 310 are closed. In other words, the high-side FETs 310 are connected between the battery power supply and the motor phase coil.

The drain of the low-side FETs 315 is connected to the motor 215 (e.g., phase coils of the motor 215) and the source of the low-side FETs 315 is connected to ground. In other words, the low-side FETs 315 are connected between the motor phase coil and ground. The low-side FETs 315 provide a current path between the motor phase coils and ground when closed.

When the FETs 310, 315 are closed (or ON), the FETs 310, 315 allow a current flow through the phase coils. In contrast, when the FETs 310, 315 are open (or OFF), the FETs 310, 315 prevent a current flow through the phase coil. The FETs 310, 315 are characterized by a relatively high drain-source breakdown voltage (e.g., between 120 V to 220 V), a relatively high continuous drain current (e.g., between 50 A to 90A), a relatively high pulsed drain current (e.g., over 300 A), and a drain-source on-state resistance (R_{DS (on)}) of less than 15 m22.

In contrast, FETs used in existing power tool devices were not rated for such high voltage and current characteristics. Accordingly, existing power tool devices would not be capable of handling such high current and voltage characteristics.

The gate drivers 305 provide a gate voltage to the FETs 310, 315 to control the FETs 310, 315 to open or close. The gate drivers 305 receive an operating power supply (e.g., a low-voltage power supply) from the battery pack 10, 10A. The gate drivers 305 also receive control signals, one each for the high-side current path and the low-side current path, from the second controller 240. The gate drivers 305 provide a control gate voltage (e.g., from the low-voltage power supply) to the FETs 310, 315 based on the control signals received from the second controller 240.

In some embodiments, the second controller 240 and the gate drivers 305 may control only the low-side FETs 315 to operate the motor 215. In other embodiments, the second controller 240 and the gate drivers 305 may control only the high-side FETs 310 to operate the motor 215. In other embodiments, the second controller 240 and the gate drivers 305 alternate between controlling the high-side FETs 310 and the low-side FETs 315 to operate the motor 215 and to distribute the thermal load between the FETs 310, 315.

In some embodiments, the inverter bridge 300 may also include a current sensor provided in the current path to detect a current flowing to the motor 215. The output of the current sensor is provided to the second controller 240. The second controller 240 may control the motor 215 further based on the output of the current sensor.

With reference to FIG. 2, a discharge switch 255 is provided on a current path between the power terminals and the inverter bridge 300 of the implemented circuit. The discharge switch 255 may be implemented using, for example, a metal-oxide-semiconductor field effect transistor (MOSFET). When the discharge switch 255 is open, current flow is stopped between power terminals and the inverter bridge 300.

A discharge controller 250 controls the discharge switch 255 (that is, opens and closes the discharge switch 255). The discharge controller 250 may be a logic circuit, a hardware implemented state machine, an electronic processor, etc. The discharge controller 250 receives inputs from the first controller 245, the second controller 240, and the trigger and provides a control signal to the discharge switch 255. The discharge controller 250 may also provide a status indication to the first controller 245 indicating whether the discharge switch 255 is open or closed.

Several techniques may be contemplated to implement a discharge control scheme of the power tool device 200 using the discharge switch 255 besides the main embodiments that include a low quiescent current circuit. In one example, the discharge controller 250 may be an AND gate that implements a logic system with inputs from the first controller 245, the second controller 240, and the trigger assembly 230. The discharge controller 250 may close the discharge switch 255 only when the trigger, the first controller 245, and the second controller 240 provide controls signals to close the discharge switch 255.

In some embodiments, it may be desirable to close the discharge switch 255 to operate the motor 34 when the trigger is operated and the first controller 245 and the second controller 240 are ready for the operation. In these embodiments, the discharge controller 250 may close the discharge switch 255 from the trigger, the first controller 245, and the second controller 240. Accordingly, when one of the first controller 245 and the second controller 240 generates an interrupt due to detecting a problem, or when the trigger is released, the discharge controller 250 opens the discharge switch 255 to prevent current flow to the inverter bridge 300. In some embodiments, when the first controller 245 or the second controller 240 detects an overvoltage condition, an overcurrent condition, an overheating condition, etc., the first controller 245 or the second controller 240 may generate or terminate a signal to the discharge controller 250 to open the discharge switch 255.

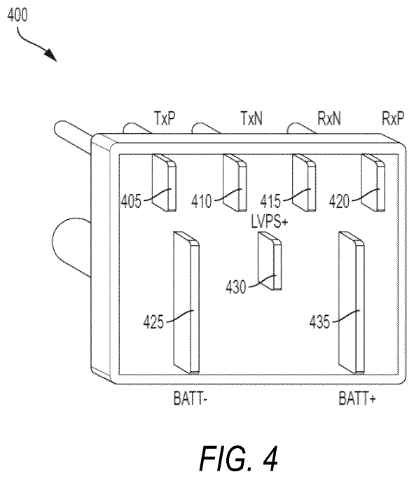

FIG. 4 illustrates a tool terminal block 400 including a positive power terminal 425, a ground terminal 435, a low-power terminal 430, a positive transmission terminal 405, a negative transmission terminal 410, a positive receiver terminal 420, and a negative receiver terminal 415. The positive power terminal 425 and the ground terminal 435 are connected to power terminals (i.e., a positive battery terminal and a ground terminal) of the battery pack 10, 10A to receive a main discharging current for the operation of the implemented circuit. The low-power terminal 430 receives a low-power voltage supply from a low-power terminal of the battery pack 10, 10A to power certain functions of the tool.

The positive transmission terminal 405, the negative transmission terminal 410, the positive receiver terminal 420, the negative receiver terminal 415 may together be referred to as “communication terminals” of the implemented circuit. The communication terminals allow for differential communication between the battery pack 10, 10A and the power tool device 200. In other embodiments, the tool communication terminals follow a full-duplex standard (for example, RS485 standard).

Referring back to FIG. 2, the positive power terminal 425 and the ground terminal 435 are electrically coupled to the inverter bridge 225 and provide a current path to operate the motor 215. The communication terminal (i.e., the positive transmission terminal 405, the negative transmission terminal 410, the positive receiver terminal 420, and the negative receiver terminal 415 may be coupled to first controller 245, for example, through a power tool device transceiver. The communication terminal provides the communication link 265 between the first controller 245 and a battery pack controller.

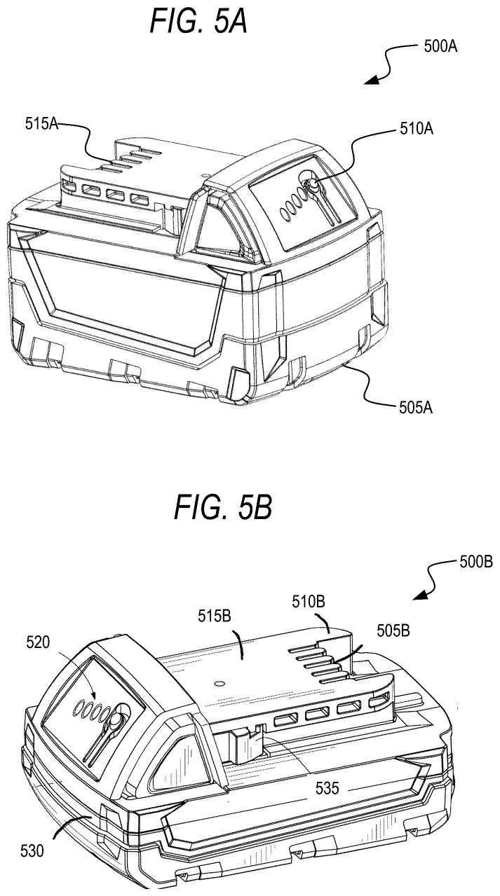

FIG. 5A illustrates an embodiment of a battery pack 500A. The battery pack 500A includes a housing 505A, a user interface portion 510A for providing a state-of-charge indication for the battery pack 500A, and a device interface portion 515A for connecting the battery pack 500A to a device (e.g., a power tool). The battery pack 500A includes a plurality of battery cells within the housing 505A.

FIG. 5B illustrates another embodiment of a battery pack 500B. The battery pack 500B includes the battery housing 530 comprising a wall having an inside surface and an outside surface. The inside surface defines an internal cavity. The outside surface includes a top surface portion 515B and a bottom portion. The battery cells disposed within the cavity are connected in series to battery contacts 505B. The contacts 505B are disposed on the top surface portion 515B, within a battery contacts housing extension 510B. The housing extension 510B is configured to matingly engage with one or more power tools or powered accessories. A battery charge level indicator 520 is also disposed on the housing, while additional battery charging, monitoring, and indication components are disposed within the cavity. As shown in FIG. 5B, two tabs 535 are coupled to the housing 530 for releasably securing the housing 530 to a power tool. Corresponding features to those described above with respect to the battery pack 500A can also be included in the battery pack 500B.

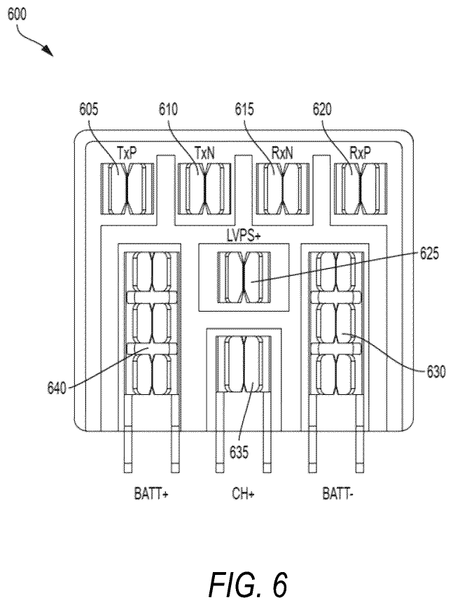

FIG. 6 illustrates a battery terminal block 600 for interfacing with the tool terminal block 400 of the power tool device 200. The battery terminal block 600 is operable to electrically connect the battery pack 10, 10A and the power tool device 200 and, as illustrated, includes a positive battery terminal 640, a ground terminal 630, a charger terminal 635, a low-power terminal 625, a positive transmission terminal 605, a negative transmission terminal 610, a positive receiver terminal 620, and a negative receiver terminal 615. The positive battery terminal 640 and the ground terminal 630 are connectable to power terminals (i.e., positive power terminal 425 and ground terminal 435) of the power tool device 200. The charger terminal 635 and the ground terminal 630 are connected to charging terminals of a charger and receive charging current to charge the battery cells of the battery pack 10. In some embodiments, the battery pack terminals 630, 640 may be made of F-Tec material (a copper, phosphorus material) to offer battery thermal distribution capabilities and durability.

The ground terminal 630 may form a common reference between the battery pack 10, 10A and the power tool device 200. The low-power terminal 625 provides a low-power voltage supply to the power tool device 200 to power certain functions of the power tool device 200. For example, the low-power voltage supply may be used to power the first controller 245, the second controller 240, the gate drivers 305, indicators (e.g., LEDs), a communication module, etc., of the power tool device 200.

The positive transmission terminal 605, the negative transmission terminal 610, the positive receiver terminal 620, and the negative receiver terminal 615 may together be referred to as “battery communication terminals” of the battery pack 10, 10A. The battery communication terminals allow for differential communication between the battery pack 10 and the power tool device 200 or charger. The battery communication terminals and the communication terminals of the power tool device 200 together may be referred to as the communication link 265. In other embodiments, the communication terminals follow a full-duplex standard (for example, RS485 standard).

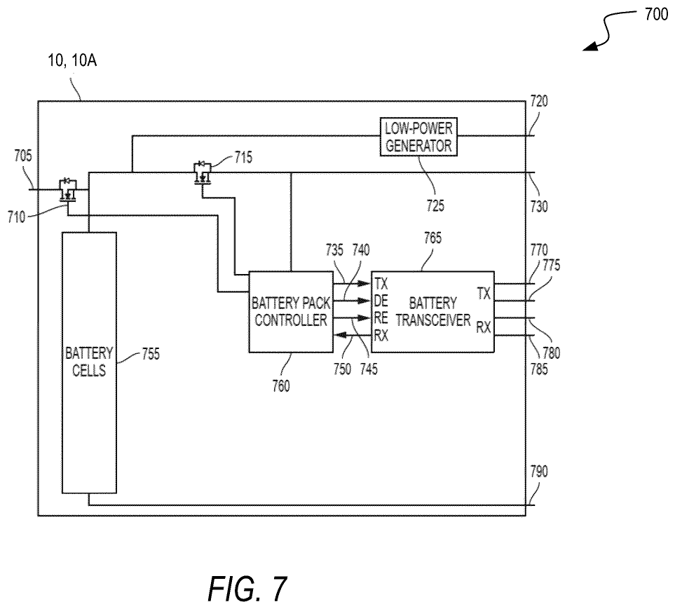

FIG. 7 is a simplified block diagram of the battery pack 10, 10A. The battery pack 10, 10A includes battery cells 755, a battery controller 760, a low-power generator 725, and a battery transceiver 765. The battery controller 760 may be implemented in ways similar to the first controller 245 and the second controller 240.

In some embodiments, a battery discharging switch 715 is connected between the battery cells 755 and the positive battery terminal 730. The battery controller 760 is operable to control (e.g., open and close) the discharging switch 715 to control discharge of the battery cells 755. In some embodiments, a charging switch 710 may also be connected between the battery cells 755 and the charger terminal 705. The battery controller 760 is operable to control (e.g., open and close) the charging switch 710 to control charging of the battery cells 755. In some embodiments, when the discharging switch 715 and the charging switch 710 are implemented using MOSFETs, two MOSFETS, in series, may be used as the discharging switch 715 and the charging switch 710. This allows the discharging switch 715 and the charging switch 710 to prevent any current flow in either direction when the discharging switch 715 and the charging switch 710 are open.

The discharging switch 715 and the charging switch 710 may be implemented using bi-polar junction transistors, field-effect transistors (FETs), etc. In some embodiments, the discharging switch and the charging switch 710 may be connected on the ground-side of the battery cells 755 between the battery cells 755 and the ground terminal 790. In some embodiments, the ground terminal 790 may be split into a charging path ground terminal and a discharging path ground terminal.

The low-power generator 725 is connected between the battery cells 755 and the low-power terminal 720. The low-power generator 725 provides a low-power voltage supply at the low-power terminal 720 to the power tool device 200. In some embodiments, the battery controller 760 may provide control signals to the low-power generator 725 to control the operation of the low-power generator 725.

In the illustrated example, the battery transceiver 765 is implemented as a differential communication transceiver (e.g., Texas Instruments SN65HVD7 Full Duplex RS-485 Transceiver). The battery transceiver 765 receives a transmission signal 735 from the battery controller 760 and sends a receiver signal 750 to the battery controller 760.

The battery transceiver 765 is also connected to the communication terminals (770, 775, 780, and 785). When the battery pack 10 transmits a communication signal to the power tool device 200 or charger, the battery controller 760 sends a transmission enable signal 740 in addition to a transmission enable signal 740 to the battery transceiver 765. When the battery transceiver 765 receives the transmission enable signal 740, the battery transceiver 765 converts the transmission signal 735 to complementary transmission signals at the positive transmission terminal 770 and the negative transmission terminal 775. When the battery transceiver 765 receives a receiver enable signal 745 from the battery controller 760, the battery transceiver 765 receives complementary signals from the positive receiver terminal 780 and the negative receiver terminal signal 750 to the battery controller 760. The power tool device 200 may similarly include a power tool device transceiver that interacts with the first controller 245 in a similar way to provide communications with the battery controller 760.

In other embodiments, rather than the battery transceiver 765, the battery pack 10 may include separate transmitting and receiving components, for example, a transmitter and a receiver.

The battery controller 760 communicates with the first controller 245 through the battery terminals via the communication link 265 (e.g., an RS-485 link). The communication link 265 between the battery controller 760 and the first controller 245 may be used for battery pack 10, 10A and power tool device 200 authentication or to exchange other information (e.g., discharge capabilities of the battery pack 10, 10A). The first controller 245 and the battery controller 760 may be configured such that the first controller 245 and the battery controller 760 exchange communications at a certain time interval. The time interval may be, for example, between 3 ms to 15 ms.

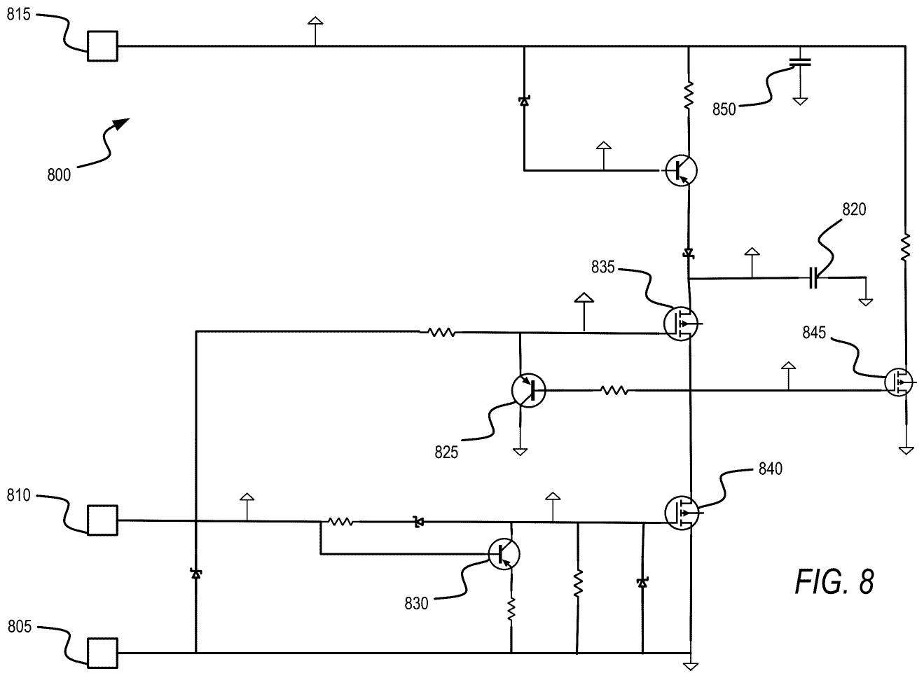

FIG. 8 illustrates a low quiescent current DC link bus discharge circuit 800 for the power tool 200. The circuit 800 includes a battery pack negative terminal 805 (e.g., a lowest potential terminal connected to the battery packs 500A, 500B), an intermediate voltage terminal 810 (e.g., corresponding to the battery pack positive voltage of a first battery pack 500A, 500B), and a DC link bus terminal 815 (e.g., a highest potential terminal connected to the battery packs 500A, 500B). When two battery packs are connected to the power tool 200, the DC link bus terminal 815 corresponds to a combined, series voltage of the two battery packs (e.g., 36V-40V). When either battery pack is removed from its battery pack receiving interface of the power tool 200, the voltage of the DC link bus terminal can remain high if the DC link bus capacitance is charged. A discharge transistor hold-up capacitor 820 is charged when the voltage at the DC link bus terminal 815 is greater than a first threshold value (e.g., 25V, between 18V and 36V, etc.) and the voltage at the intermediate voltage terminal is greater than a second threshold value (e.g., 18V, 10V-18V, etc.). The discharge transistor hold-up capacitor 820 can be charged to a DC link voltage value of, for example, 10-15V. The voltage at the intermediate voltage terminal 810 will be greater than or approximately equal to the second threshold value when the first battery pack 500A, 500B is attached to the power tool 200 or if the second battery pack 500A, 500B is attached to the power tool 200 and the discharge transistor hold-up capacitor 820 is charged.

Switches 825 and 830 (e.g., bi-polar junction transistors, FETs, MOSFETs, etc.) are configured for asymmetric switching of a first DC link switch 835 and a second DC link switch 840. The second DC link switch 840 is turned ON or activated if the voltage of the intermediate voltage terminal 810 is greater than a battery pack presence voltage threshold value (e.g., 10V), which indicates that a first battery pack 500A, 500B is connected to the power tool 200. In some embodiments, the first DC link switch 835 is a PMOS transistor and the second DC link switch 840 is an NMOS transistor. When the second DC link switch 840 is ON, a DC link discharge switch 845 (e.g., bi-polar junction transistors, FETs, MOSFETs, etc.) is correspondingly turned OFF. In some embodiments, the DC link discharge switch 845 is an NMOS transistor. When the first battery pack 500A, 500B is removed from the power tool 200, the second DC link switch 840 is turned OFF.

The first DC link switch 835 being OFF or deactivated ensures a low quiescent current for the power tool 200 (e.g., below a threshold quiescent current value, such as less than or equal to 5 micro-Amps [“μA”]). The first DC link switch 835 is turned ON or activated if the voltage at the DC link terminal 815 is greater than the first threshold value (e.g., greater than 25V) and the voltage at the intermediate voltage terminal 810 is zero (0) voltages. Such a situation occurs when the DC link bus capacitance (not show) is charged and both first and second battery packs 500A, 500B are removed or detached from the power tool 200. In such an instance, with the first DC link switch 835 ON, and the second DC link switch 840 OFF (because the first battery pack 500A, 500B is removed), the DC link discharge switch 845 is turned ON or activated. When the DC link discharge switch 845 and the first DC link switch 835 are both ON, the discharge transistor hold-up capacitor 820 is discharged to ground. With the discharge transistor hold-up capacitor 820 being discharged, there is no risk or arcing or shock from, for example, a user contacting the battery pack receiving terminals of the power tool 200 (e.g., corresponding to the DC link bus terminal 815 and the intermediate voltage terminal 810). In FIG. 8, the DC link bus capacitance is illustratively shown as capacitor 850. Although only one capacitor 850 is illustrated to represent the DC link bus capacitance, the capacitor 850 can represent an aggregation of capacitance on the DC link bus from multiple capacitors or other sources of capacitance.

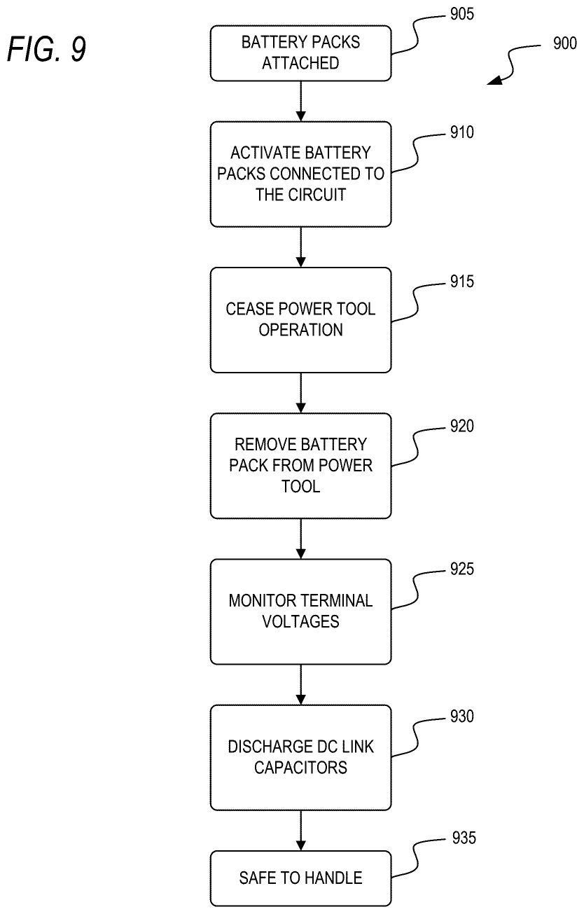

FIG. 9 illustrates a low quiescent current capacitance discharge method 900. The battery pack powered power tool 200 can receive multiple (e.g., two) battery packs and can be switched ON by a user (STEP 905), which initiates an operation of the battery pack powered power tool 200. This activates the battery packs connected to the circuit 800 illustrated in in FIG. 8 (STEP 910) to discharge current for powering the power tool 200. The terminals of the battery packs are electrically coupled to the circuit 800 of FIG. 8 at the terminals 805, 810, 815, and the battery pack powered tool 200 monitors the DC link bus terminal 815 and the intermediate voltage terminal 810. Once the user ends their task or operation with the power tool 200, the power tool operation is ceased (STEP 915), therefore power is no longer needed to be transferred from the battery packs to the power tool 200. As described above, the first DC link switch 835 being OFF ensures a low quiescent current for the power tool 200. As a result, if the battery packs 500A, 500B remain attached to the power tool 200, the quiescent current drawn by the power tool 200 will be very low (e.g., less than 5 μA).

In order to ensure that the terminals of the power tool 200 are safe for a user to touch when the battery packs 500A, 500B are removed, the voltage of the DC link bus terminal 815 and the voltage of the intermediate voltage terminal 810 (shown in and described with respect to FIG. 8) are monitored (STEP 925) to detect if one or both of the battery packs has been removed (i.e., detached) from the power tool 200. If the voltage at the DC link bus terminal 815 is above, for example, the first threshold value (e.g., 25V) and the voltage at the intermediate voltage terminal 810 is greater than the second threshold value (e.g., 18V), the controller 240, 245 can determine that two battery packs are connected to the power tool 200. If the high-side battery pack (e.g., corresponding to the highest potential terminal at the DC link bus) is removed from the power tool 200 and the low-side battery pack is removed with the discharge transistor hold-up capacitor 820 being charged (e.g., to 10V-15V), the controller 240, 245 will measure a voltage at the DC link bus terminal 815 that is greater than the first threshold value (e.g., 25V) and a voltage at the intermediate voltage terminal 810 that is zero (0) volts. In such a situation, the discharge transistor hold-up capacitor 820 is discharged by the DC link discharge switch 845 (STEP 930), as described above with respect to FIG. 8. Once the discharge transistor hold-up capacitor 820 is discharged, the battery pack terminals of the power tool 200 are safe to the touch (STEP 935).

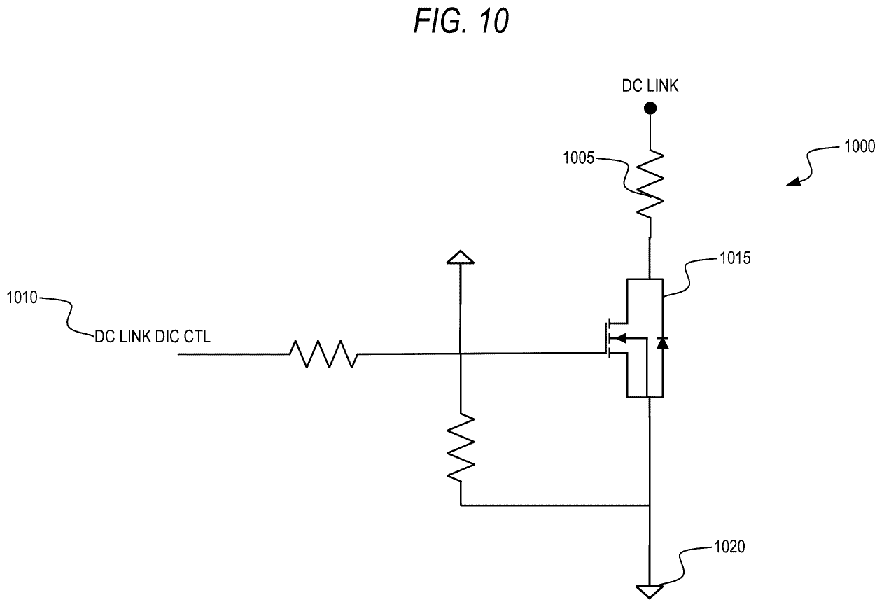

FIG. 10 illustrates another embodiment of a circuit for safely discharging DC link capacitors or capacitance. FIG. 10 illustrates a DC link capacitor discharge circuit 1000 that includes a discharge resistor 1005, a controller pin 1010 (e.g., from the controller 240, 245), and a discharge switch 1015 (e.g., a FET) for connecting the discharge resistor 1005 to ground 1020. When battery packs (e.g., two battery packs) are connected to the power tool 200, the combined series voltage of the battery packs corresponds to the voltage of the DC link bus of the power tool 200. The positive end of the discharge resistor 1005 is connected to the DC link bus. During operation of the power tool 200, the battery packs are connected to the DC link bus by a solid state disconnect circuit to provide power for driving a motor. However, when operation of the tool has ended, the solid state disconnect circuit can be used to disconnect the battery pack voltage from the DC link bus. The voltage from the DC link capacitance can then be discharged by the DC link capacitor discharge circuit 1000. For example, after a predetermined time delay following the end of operation of the power tool 200 (e.g., after sensed trigger release, after a motor has stopped rotating, etc.), the controller 240, 245 is configured to provide an ON signal to the controller pin 1010 to turn on the discharge switch 1015. After the discharge switch 1015 is turned ON, the charge stored by the DC link capacitance for the DC link bus is discharged through the discharge resistor 1005. As a result of the discharge switch 1015 being OFF, the quiescent current drawn by the power tool 200 will be very low (e.g., less than 5 μA).

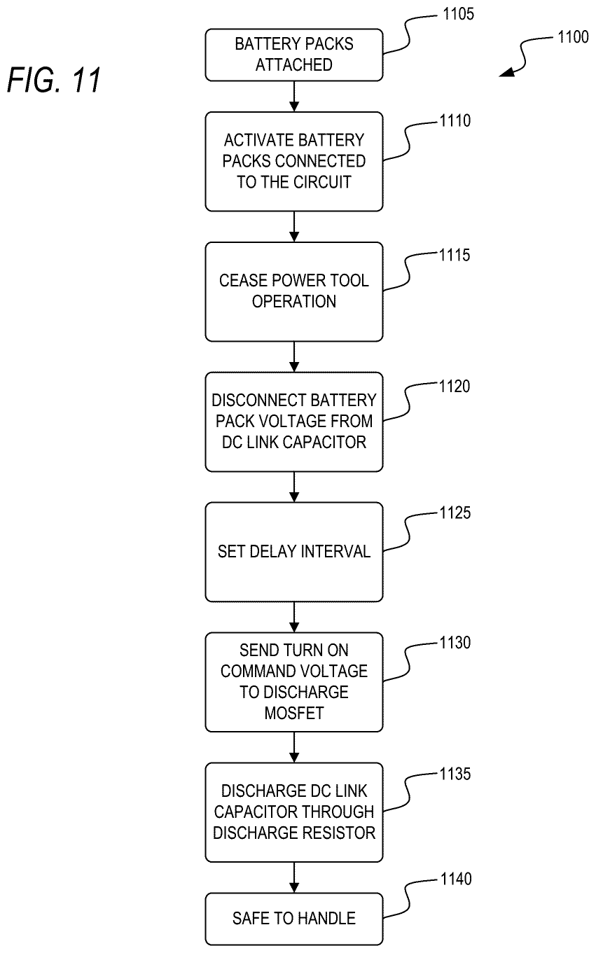

FIG. 11 illustrates a control process 1100 for the circuit of FIG. 10. The user first connects the plurality of battery packs 500A, 500B to the power tool 200 (STEP 1105), and subsequently turns the power tool 200 ON (STEP 1110). By turning the power tool 200 ON, the battery packs are activated (STEP 1110) and will provide power to a motor of the power tool 200. In operation, a solid state disconnect circuit (e.g., main power tool power switch) connects the battery pack voltage to the DC link bus to allow for driving a motor of the power tool 200. Once the user finishes working with the power tool, the power tool operation is ceased (STEP 1115), stopping the motor of the power tool 200. Power tool operation may be halted through a variety of different methods and/or systems (e.g., releasing a trigger, predetermined halting control, etc.). The battery pack voltages are then disconnected from the DC link capacitance (STEP 1120) using the solid state disconnect circuit. After the battery pack voltage is disconnected from the DC link bus and DC link bus capacitance, a delay interval or period is set in the controller 240, 245 (STEP 1125). At the end of the delay interval or period, the controller 240, 245 provides a turn ON command to the controller pin 1010 (STEP 1130) in order to discharge the DC link capacitance's voltage through a discharge resistor 1005 (STEP 1135). Once the DC link capacitance are discharged, the battery pack terminals of the power tool 200 are safe to touch (STEP 1140).

Thus, embodiments described herein provide, among other things, systems and methods to discharge DC link bus capacitance to ensure safe to touch battery terminals. Various features and advantages are set forth in the following claims.

What is claimed is:

1. A power tool device comprising:
a housing;
a battery pack interface configured to receive at least one battery pack;
a first battery pack terminal and a second battery pack terminal;
a low quiescent current direct current (“DC”) link bus discharge circuit including a DC link bus capacitance, a first DC link bus switch, and a second DC link bus switch; and
a controller configured to:
monitor a voltage of the first battery pack terminal,
monitor a voltage of the second battery pack terminal,
activate the first DC link bus switch and the second DC link bus switch when the voltage of the first battery pack terminal is greater than a first threshold value and the voltage of the second battery pack terminal is zero volts.

2. The power tool device of claim 1, further comprising a third DC link bus switch connected to the first DC link bus switch.

3. The power tool device of claim 2, wherein the controller is configured to activate the third DC link bus switch is when the voltage of the second terminal is greater than a battery pack presence voltage threshold value.

4. The power tool device of claim 3, wherein the battery pack presence voltage threshold value is 18V or less.

5. The power tool device of claim 1, wherein the first DC link bus switch is deactivated when the voltage of the first battery pack terminal is greater than the first threshold value and the voltage of the second battery pack terminal is greater than a second threshold value.

6. The power tool device of claim 1, wherein the at least one battery pack includes a first battery pack and a second battery pack.

7. The power tool device of claim 6, wherein the first threshold value is between 18V and 36V.

8. The power tool device of claim 7, wherein the first threshold value is 25V.

9. A power tool device comprising:
a housing;
a battery pack interface configured to receive at least one battery pack;
a low quiescent current direct current (“DC”) link bus discharge circuit including a discharge resistor and a discharge switch; and
a controller configured to:
determine when the power tool device is not in operation,
implement a delay interval subsequent to it being determined that the power tool device is not in operation,
activate, after an end of the delay interval, the discharge switch to discharge voltage stored on a DC link bus through the discharge resistor.

10. The power tool device of claim 9, wherein the controller is configured to provide a turn ON command to a controller pin after the end of the delay interval.

11. The power tool device of claim 9, wherein the power tool device is configured to disconnect the battery pack interface from a DC link capacitance using a solid state disconnect circuit.

12. The power tool device of claim 9, wherein the controller is configured determine a safe to handle state of the power tool device.

13. A method of controlling a power tool device, the method comprising:
monitoring a voltage of a first battery pack terminal;
monitoring a voltage of a second battery pack terminal;
activating a first DC link bus switch and a second DC link bus switch when the voltage of the first battery pack terminal is greater than a first threshold value and the voltage of the second battery pack terminal is zero volts.

14. The method of claim 13, further comprising:
activating a third DC link bus switch when the voltage of the second terminal is greater than a battery pack presence voltage threshold value.

15. The method of claim 14, wherein the battery pack presence voltage threshold value is 18V or less.

16. The method of claim 13, the method further comprising:
deactivating the first DC link bus switch when the voltage of the first battery pack terminal is greater than the first threshold value and the voltage of the second battery pack terminal is greater than a second threshold value.

17. The method of claim 13, wherein the first threshold value is between 18V and 36V.

18. The method of claim 17, wherein the first threshold value is 25V.

19. The method of claim 13, further comprising determining a safe to handle state of the power tool device.

20. The method of claim 13, further comprising connecting the first battery pack terminal to a first battery pack and the second battery pack terminal to a second battery pack.
